(19) United States
(12) Patent Application Publication
(10) Pub. No.: US 2010/0295253 A1
(43) Pub. Date: Nov. 25, 2010

(54) PACKING AND SEALING SYSTEM

(75) Inventors: Hikaru Tadano, Nihonmatsu-shi (JP); Hisashi Kato, Aomori-shi (JP)

Correspondence Address: HARNESS, DICKEY & PIERCE, P.L.C., P.O. BOX 828, BLOOMFIELD HILLS, MI, 48303, US

(73) Assignee: NOK Corporation, Tokyo (JP)

(21) Appl. No.: 12/517,975

(22) PCT Filed: Dec. 5, 2007
(86) PCT No.: PCT/JP2007/073493

§ 371 Date: Jun. 5, 2009

(30) Foreign Application Priority Data
Dec. 6, 2006 (JP) 2006-329731

(51) Int. Cl. F16J 15/32

(52) U.S. Cl. 277/549

(57) ABSTRACT

A packing and a sealing system capable of enhancing an accumulation avoiding function. A packing fitted to an annular groove provided in one member out of a housing having a shaft hole and shaft to be inserted into the shaft hole to seal the annular gap between the two members, which comprise a base and a lip portion projecting from the groove bottom side of the annular groove in the base toward a sealed object side, and which is constituted such that, when the peripheral surfaces on the groove bottom side of the annular grooves in the base and the lip portion tightly contact the groove bottoms of the annular grooves and a pressure on a non-sealed object side goes higher than a pressure on a sealed object side, the base and the lip portion deform to allow the sealed object side to communicate with the non-sealed object side at contact portions with the groove bottoms of the annular grooves and thereby reduce a pressure on the non-sealed object side, wherein the base is provided with a pressure guide path for allowing a contact portion between the lip portion and the groove bottom of the annular groove to communicate with the non-sealed object side.

### TECHNICAL FIELD

The present invention relates to a packing used in a hydraulic cylinder or suchlike and to a sealing system which has the packing.

### BACKGROUND ART

Conventionally, a rod sealing system or the like is known as a sealing system for a hydraulic cylinder. The rod sealing system is used in a hydraulic cylinder or suchlike, which is used as an actuator as for a construction machine or conveying vehicle. Referring to FIG. 6, a description is given of a typical hydraulic cylinder in which a conventional rod sealing system is used. FIG. 6 is a perspective view illustrating the configuration of a schematic section of the hydraulic cylinder.

This hydraulic cylinder 101 includes: a cylinder 102; a piston 103 inserted into the cylinder 102 so as to slide freely; and a rod 104 connected to the piston 103. In addition, the hydraulic cylinder 101 is provided with a rod sealing system, which is fitted in a mounting groove in an end part of the cylinder 102, thereby sealing the gap between the inner circumference of the cylinder 102 and the rod 104.

The cylinder 102 has two oil pressure introducing holes 105 and 106 located at each side of the piston 103. By applying the pressure of an operating oil selectively to the oil pressure introducing hole 105 or 106, thereby axially moving the piston 103 and changing the relative positions of mounting parts 107 and 108 of the cylinder 102 and rod 104.

Referring to FIG. 7, the rod sealing system will now be described. FIG. 7 is a half sectional view of the configuration of the rod sealing system according to a conventional technique.

The rod sealing system includes: a rod packing R which prevents an operating oil from leaking outside; a buffer ring B which is fitted to the oil pressure side of the rod packing R, absorbs the impact pressure or pressure fluctuation when high load is applied or cuts down the high temperature operating oil flowing toward the rod packing R, and thereby improves the durability of the rod packing R; and a dust seal D which is located on the outside of the rod packing R and prevents entry of muddy water or dust.

The buffer ring B includes: a U-shaped packing 110 which has an inner circumference lip portion 112 and outer circumference lip portion 113 projecting toward the oil pressure Side O from the inner circumference and outer circumference, respectively, of the base 111 and which has a U-shaped annular groove (U-shaped groove) 114 formed between the inner circumference lip portion 112 and outer circumference lip portion 113; and a backup ring 115 which is fitted on the inner circumference side of the base 111 of the U-shaped packing 110. The rod packing R includes a U-shaped packing 120 and a backup ring 121 fitted on the outside of the U-shaped packing. The dust seal D has a fitting part on the outer circumference thereof to which a metal ring 133 is fixed by baking, a dust lip 131, and an oil lip 130.

The packing 110 composing the buffer ring B is an annular member made of a rubber material such as polyurethane rubber. The packing 110 is fitted in an annular groove 102a provided in the inner circumference face of the cylinder 102. The inner circumference lip portion 112 slides on the outer circumference face of the rod 104, and the outer circumference lip portion 113 comes into close contact with the groove bottom 102b of an annular groove 102a.

The operating oil sealed at the oil pressure side O of the buffer ring B slightly leaks on the rod packing side R due to forward or backward movement of the piston 103 and rod 104. The accumulation of the leakages of the operating oil by the repetition of the forward or backward movement of the piston 103 and rod 104 results in an accumulation of the operating oil in the space S between the buffer ring B and rod packing R. After the space S is filled with the operating oil, the pressure of the operating oil in the space S increases (i.e., pressure accumulation).

If pressure accumulates in the space S, as described above, pressure is constantly applied to the rod packing R, and consequently wear, heat generation, and slide resistance increase, leading to a decrease in the durability life of the rod sealing system and degradation in the operating characteristics of the rod sealing system.

Several means for avoiding such pressure accumulation have been proposed.

For example, one of such means is designed as described below. The thickness of the outer circumference lip portion of a U-shaped packing is decreased relative to that of an inner circumference lip portion, thereby making it easy for the outer circumference lip portion to be deformed more easily than the inner circumference lip portion. Accordingly, the outer circumference side of the U-shaped packing is deformed elastically so that the sealed side and the opposite side to the sealed side may communicate when the pressure between the buffer ring and rod packing increases. Thus, pressure accumulation is avoided (refer to Patent Document 1).

Another means is designed as describe below. If the pressure between the buffer ring and rod packing increases and the U-shaped packing is pressed toward the sealed side, the inner circumference lip portion and the outer circumference lip portion are brought into contact with the side faces of a fitting groove, resulting in the U-shaped groove being sealed with pressure accumulating in this groove. In order to avoid such a situation, a slit is formed in the face of the leading end of the inner circumference lip portion (refer to Patent Document 1).

In addition, other means for avoiding pressure accumulation are designed to form a groove on the inner circumference face of a backup ring (refer to Patent Documents 2 and 3). Examples of the related technologies are disclosed in Patent Documents 4 and 5.

Patent Document 1: Japanese Patent Application Laid-Open No. 2001-355739

Patent Document 2: Japanese Utility Model Application Laid-Open No. 1-152151

Patent Document 3: Japanese Patent Application Laid-Open No. 2004-28160

Patent Document 4: Japanese Patent Application Laid-Open No. 2004-19782

Patent Document 5: Japanese Patent Application Laid-Open No. 8-326924

### DISCLOSURE OF THE INVENTION

### Problems to be Solved by the Invention

However, in the configuration in which the outer circumference side of a U-shaped packing is deformed elastically, not only the outer circumference lip portion but also a base supporting the outer circumference lip portion must be deformed. If an increase in pressure is not sufficient, the sealed side and the opposite side to the sealed side cannot communicate, making it difficult to avoid pressure accumulation.

Even if the outside diameter of the base is set smaller than the diameter of the bottom of the annular groove thereby facilitating deformation of the outer circumference side, the outer circumference face of the base may come into close contact with the groove bottom in case where the diameter of the packing increases due to, for example, long use or creep deformation caused as by heat. This eventually requires deformation of the base in order to avoid pressure accumulation.

In a configuration where the groove is formed in the backup ring disposed on the inner circumference side, the groove wears due to sliding of the backup ring. Accordingly, the function of the groove may be lost over long use. Where the groove is formed deep in order to restrain wear, part of a packing may be squeezed into the groove. This degrades the intended function of the backup ring, which is to restrain the packing from being squeezed out.

The present invention has been proposed to overcome the problems of the conventional technique described above. It is accordingly an object of the present invention to provide a packing capable of improving a pressure accumulation avoiding function and to provide a sealing system which has this packing.

### Means for Solving the Problems

In order to achieve the foregoing object, the present invention provides a packing which is fitted in an annular groove formed in one member of a housing having a shaft hole and a shaft inserted into the shaft hole, and which seals an annular gap between these two members;
the packing having a base, and a lip portion which projects toward a sealed side from a side of the base being on the bottom side of the annular groove, and
the packing being configured such that the base and a circumferential face of the lip portion, the circumferential face being on the bottom side of the annular groove, are brought into close contact with the bottom of the annular groove, and such that when pressure on an opposite side to the sealed side becomes higher than pressure on the sealed side, the base and the lip portion are deformed to enable the sealed side and the opposite side to the sealed side to communicate in the contact areas between the base and the bottom of the annular groove and between the lip portion and the bottom of the annular groove, thereby reducing pressure on the opposite side to the sealed side, wherein:
the base has a pressure guide passage for enabling the contact area between the lip portion and the bottom of the annular groove to establish communication with the opposite side to the sealed side.

Simply by deforming the lip portion, the sealed side and the opposite side to the sealed side are enabled to communicate with each other. That is, even when the base is in close contact with the bottom of the annular groove, pressure on the opposite side to the sealed side acts on the lip portion, thus making it possible to deform the lip portion. Accordingly, before pressure on the opposite side to the sealed side increases to such a degree as to deform the base, the sealed side and the opposite side to the sealed side are caused to communicate to reduce pressure on the opposite side to the sealed side.

The base may have a slit in a contact face between the base and the bottom of the annular groove, and the pressure guide passage may be formed by a gap which is made in a contact area between the base and the bottom of the annular groove by the slit.

The base may have a plurality of projections in a contact face between the base and the bottom of the annular groove, and a pressure guide passage may be formed by gaps which are made between the plurality of projections.

Such configurations make it possible to form in the base the pressure guide passage through which pressure on the opposite side to the sealed side is introduced to the contact area between the lip portion and the bottom of the annular groove. This eliminates the need to deform the base and enables pressure on the opposite side to the sealed side to leak on the sealed side simply by deforming the lip portion.

The lip portion may be a first lip portion and the packing may have a second lip portion which projects toward the opposite side to the sealed side from the other member side of the base and is greater than the first lip portion in the amount of projection, and when the pressure on the opposite side to the sealed side becomes higher than the pressure on the sealed side and the packing is consequently pressed to the sealed side, the second lip portion may be brought into contact with the side wall of the annular groove, the side wall being on the sealed side.

In such a configuration, the second lip portion greater than the first lip portion in the amount of projection is brought into contact with the side wall of the annular groove, the side wall being on the sealed side. Thereby the first lip portion is restrained from coming into contact with the side wall face. This prevents such a situation as that when pressure on the opposite side to the sealed side is increased and the packing is consequently pressed to the sealed side, the first lip portion is brought into contact with the side wall of the annular groove and hindered from being deformed to establish the communication between the sealed side and the opposite side to the sealed side. In other words, even if the packing is pressed to the sealed side, deformation of the first lip portion is facilitated, which improves the pressure accumulation avoiding function.

The contact area between the second lip portion and the side wall of the annular groove, the side wall being on the sealed side, may have a communication passage by which the bottom side and opening side of the annular groove communicate with each other.

Thus, even when the second lip portion is brought into contact with the side wall of the annular groove, the space between the first and second lip portions and the sealed side are prevented from being blocked completely by the second lip portion. This suppresses an increase in pressure in the space between the first and second lip portions.

In order to achieve the object described above, the present invention provides a sealing system including:
a main seal; and
any one of the packings described above, the packing serving as a buffer ring for the main seal.

This makes it possible to improve the pressure accumulation avoiding function of the sealing system.

### EFFECT OF THE INVENTION

As described above, the present invention can improve the pressure accumulation avoiding function.

### BRIEF DESCRIPTION OF DRAWINGS

FIG. 1 is a schematic view of the configuration of a packing according to the present embodiment.

FIG. 2 is a perspective view of the configuration of the packing according to the present embodiment.

FIG. 3 is a half sectional view of a schematic configuration of a sealing system.

FIG. 4 is a half sectional view of the fitted state of the packing according to the present embodiment.

FIG. 5 is a perspective view of the configuration of a packing according to a modification.

FIG. 6 is a perspective sectional view illustrating the configuration of a hydraulic cylinder.

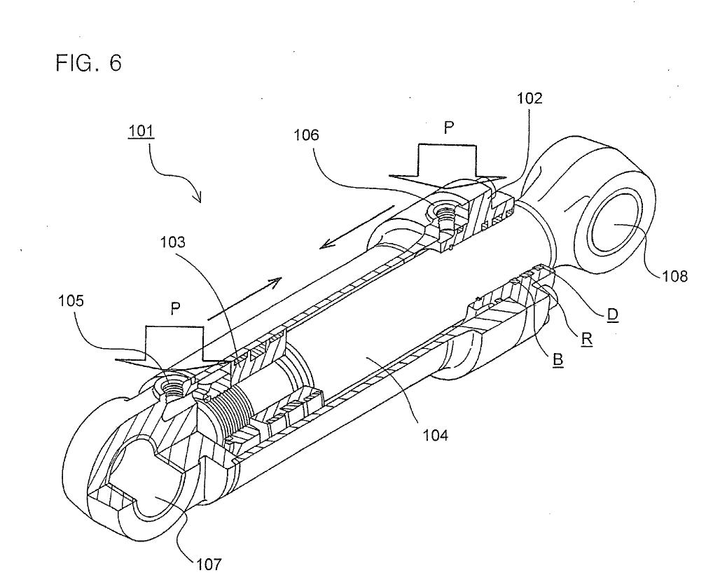

FIG. 7 is a half sectional view of the configuration of a rod sealing system according to a conventional technique.

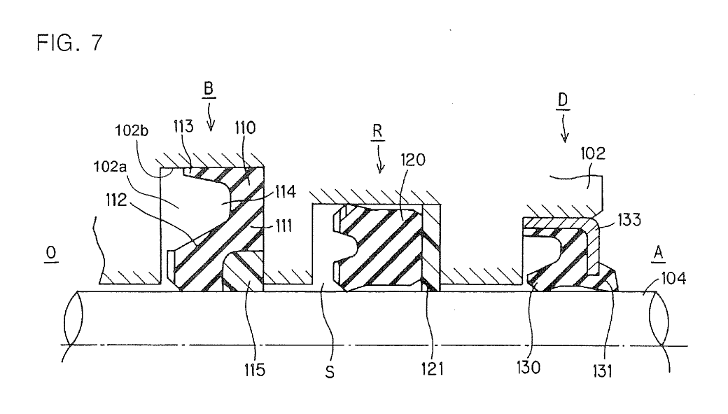

### EXPLANATIONS OF REFERENCE NUMERALS

1 PACKING
10 BASE
10a OUTER CIRCUMFERENCE FACE
10b SLIT
11 INNER CIRCUMFERENCE LIP PORTION
11a END FACE
11c INNER CIRCUMFERENCE PROJECTION
12 OUTER CIRCUMFERENCE LIP PORTION
12c OUTER CIRCUMFERENCE PROJECTION
13 U-SHAPED GROOVE
14 BACKUP RING
100 ROD SEALING SYSTEM
101 HYDRAULIC CYLINDER
101 CYLINDER
102a ANNULAR GROOVE
102b GROOVE BOTTOM FACE
102c SIDE WALL FACE
103 PISTON
104 ROD
B BUFFER RING
D DUST SEAL
R ROD PACKING

### BEST MODES FOR CARRYING OUT THE INVENTION

Based on embodiments, the best modes for carrying out the invention will hereinafter be described as an example in detail with reference to the accompanying drawings. It should be understood that dimensions, materials, shapes, relative positions, and the like of component parts described in the embodiments do not limit the scope of the invention unless otherwise stated.

### First Embodiment

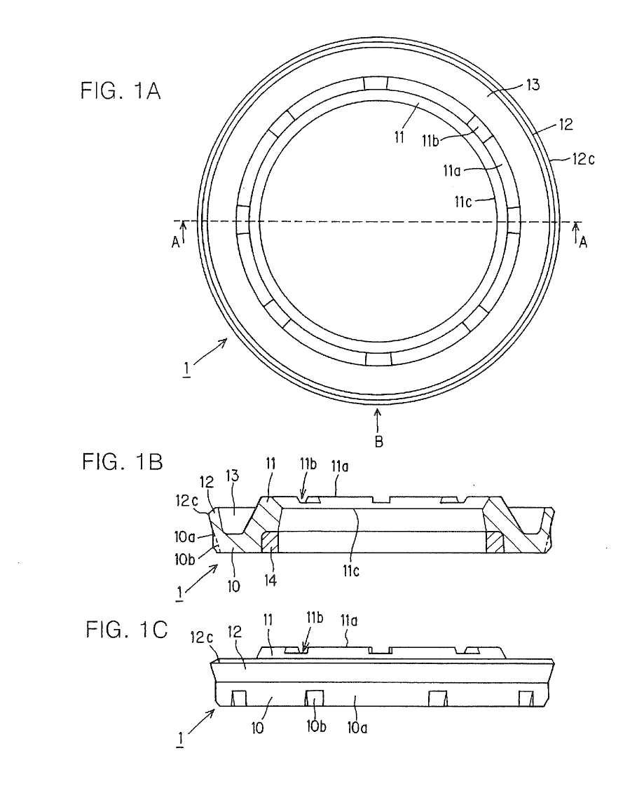

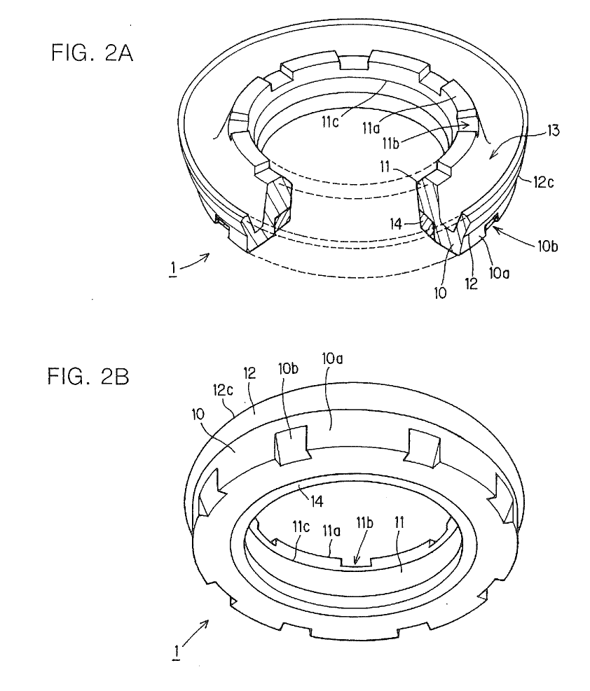

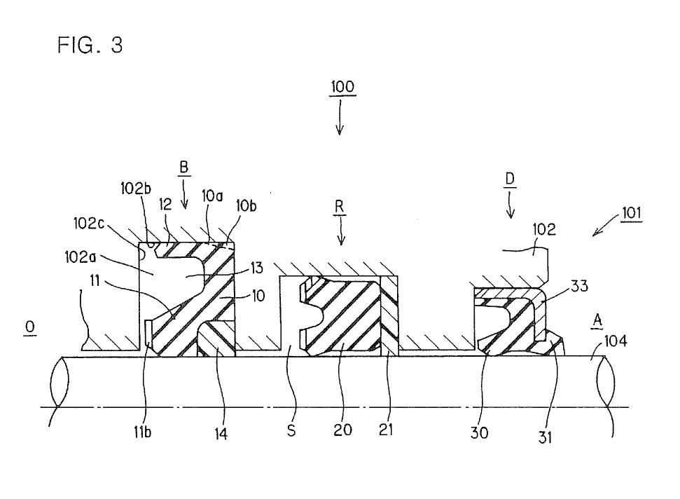

Referring to FIGS. 1 to 3, the schematic configuration of a packing according to the first embodiment of the present invention will now be described. FIG. 1 is a schematic view of the configuration of the packing according to the present embodiment. FIG. 1A shows the packing as viewed from the axial direction, FIG. 1B is a sectional view taken along line A-A of FIG. 1A, and FIG. 1C shows the packing as viewed from the arrow B in FIG. 1A. FIG. 2 is a perspective view of the configuration of the packing according to the present embodiment, FIG. 2A shows the packing as viewed from the sealed side, with a sectional view of the packing part of which has been removed. FIG. 2B is a perspective view of the packing as viewed from the opposite side to the sealed side. FIG. 3 is a half sectional view of the schematic configuration of a sealing system in which the packing according to the present embodiment is used.

### Configuration and Outline of the Packing

As shown in FIGS. 1 and 2, the packing 1 is an annular member and includes: a base 10; an inner circumference lip portion 11 (second lip portion) projecting in one direction of the axial directions from the inner circumference side of the base 10; an outer circumference lip portion 12 (first lip portion) projecting in the one direction of the axial directions from the outer circumference side of the base 10. The packing 1 is a so-called U-shaped packing, in which an approximately U-shaped cross-sectional annular groove (hereinafter, a U-shaped groove) 13 is formed between the inner circumference lip portion 11 and outer circumferential lip portion 12. In addition, the packing 1 has a backup ring 14 on the other side in the axial direction of the inner circumference lip portion 11 and on the inner circumference side of the base 10.

Examples of the material of the packing 1 include nitrile rubber, elastomer such as polyurethane elastomer or polytetrafluoroethylene (PTFE), and a resin material.

Formed in the outer circumference face 10a of the base 10 of the packing 1 are a plurality of slits 10b, which are disposed at regular intervals in the circumferential direction of the outer circumference face 10a. Each of the slits 10b is formed by notching the outer circumference face 10a of the base 10 obliquely from the outer circumference face 10a of the base 10 toward the end face on the other side in the axial direction of the base 10 such that the radial depth of the slit 10 gradually increases in the other direction of the axial directions.

The inner circumference lip portion 11 of the packing 1 is relatively greater than the outer circumferential lip portion 12 in thickness and in the amount of projection in the one direction of the axial directions. In addition, formed in the end face 11a of the inner circumference lip portion 11, which is on the one side in the axial direction, are a plurality of radially extending slits 11b, which are disposed at regular intervals in the circumferential direction.

The packing 1 is fitted in an annular groove formed in the shaft hole of a housing and seals the annular gap between the housing and a shaft inserted in the shaft hole. As an example of a detailed form of the packing 1 according to the present embodiment, a description is given of a case where the packing 1 is used in a rod cylinder system 100 for a hydraulic cylinder 101 as shown in FIG. 3. The configuration of the hydraulic cylinder 101 is the same as the conventional one described above and the explanation thereof will not be repeated. The packing 1 according to the present embodiment can be used not only in a rod sealing system as shown in FIG. 3 but also in other piston sealing system or suchlike. Needless to say, the packing 1 can be used alone as a sealing member.

As shown FIG. 3, the rod sealing system 100 includes: a rod packing R which prevents an operating oil from leaking outside; a buffer ring B which is fitted on the oil pressure side O of the rod packing R, absorbs the impact pressure or pressure fluctuation when high load is applied, cuts down the high temperature operating oil flowing toward the rod packing R side, and thereby improves the durability of the rod packing R; and a dust seal D which is disposed on the outer side A of the rod packing R and prevents entry of muddy water or dust present on the outside. In such a rod sealing system 100, the packing 1 performs the function of the buffer ring B. The rod packing R is formed by a U-shaped packing 20 and a backup ring 21 fitted on the outer side of the U-shaped packing. The dust seal D has a fitting part on the outer circumference thereof to which a metal ring 33 is fixed by baking, an oil lip 30, and a dust lip 31.

The packing 1 is fitted in an annular groove 102a formed in the inner circumference face of the cylinder 102 serving as a housing, and seals the annular gap between the rod 104, or the shaft, and the cylinder 102.

The packing 1 is fitted so that the one side in the axial directions (i.e., projecting direction of the lip portion) is on the oil pressure side O (i.e., the sealed side) and the other side in the axial directions is on the space S side, the space S being defined between the buffer ring B and the rod packing R (i.e., on the opposite side to the sealed side). As a result, the inner circumference lip portion 11 comes into contact with and slides on the outer circumference face of the rod 104 and the outer circumference lip portion 12 comes into close contact with the bottom face 102b of the annular groove 102a.

The inner circumference lip portion 11 of the packing 1 has an inner circumference projection 11c projecting radially inwardly from the inner circumference side thereof. The diameter of the leading end of the inner circumference projection 11c is smaller than the diameter of the outer circumference face of the rod 104. In addition, the outer circumference lip portion 12 of the packing 1 has an outer circumference projection 12c projecting radially outwardly from the outer circumference side thereof. The diameter of the leading end of the outer circumference projection 12c is larger than the diameter of the bottom face 102b of the annular groove 102a of the cylinder 102.

Accordingly, in the fitted state of the packing 1, the inner circumference projection 11c of the inner circumference lip portion 11 is elastically compressed radially outwardly by the outer circumference face of the rod 104 (i.e., the inner circumference projection 11c is expanded so as to increase its diameter) while the outer circumference projection 12c of the outer circumference lip portion 12 is elastically compressed radially inwardly by the bottom face 102b of the annular groove 102a (i.e., the outer circumference projection 12c is compressed so as to decrease its diameter). The inner circumference lip portion 11 and outer circumference lip portion 12 are compressed in radial directions in a manner described above, thereby coming into close contact with the outer circumference face of the rod 104 and the bottom face 102b of the annular groove 102 respectively.

The U-shaped groove 13 formed between the inner circumference lip portion 11 and outer circumference lip portion 12 receives pressure from the oil pressure side O and is elastically deformed so as to expand in radial directions. Consequently, the U-shaped groove 13 further presses the inner circumference lip portion 11 and outer circumference lip portion 12 against the outer circumference face of the rod 104 and the bottom face 102b of the annular groove 102a respectively, thus enhancing the adhesion of the lip portions.

The base 10 is designed such that even if its outside diameter becomes larger than the diameter of the groove bottom face 102b due to its dimensional tolerance in relation to the annular groove 102a or due to diameter increase or deformation of a packing 1 caused by an creep deformation or the like, a gap is ensured in the area where the slits 10b are formed or where the base 10 and the groove bottom face 102b are in contact with each other. This prevents the entire outer circumferential face 10a from coming into contact with the bottom face 102b of the annular groove 102a completely.

### Pressure Accumulation Avoiding Function

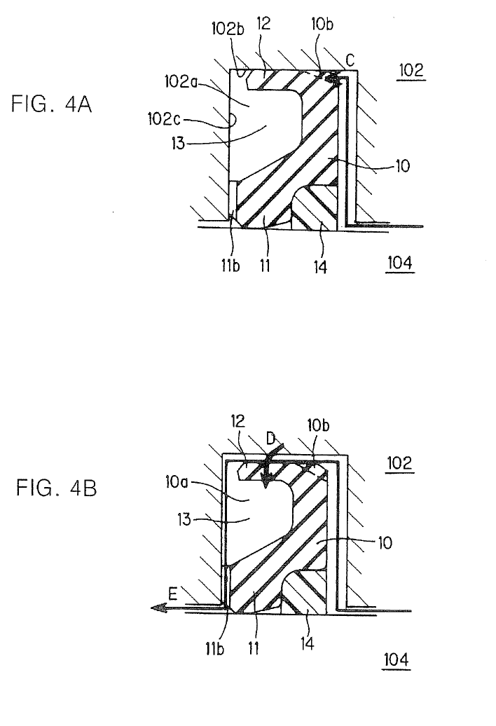

Referring to FIG. 4, next will be described the pressure accumulation avoiding function of the packing 1 according to the present embodiment. FIG. 4 is a half sectional view of the fitted state of the packing 1 according to the present embodiment. FIG. 4A shows a state in which oil pressure on the space S side is higher than oil pressure on the oil pressure side O, and FIG. 4B shows a state in which the oil pressure on the space S side is further increased from the state shown in FIG. 4A.

An operating oil sealed on the oil pressure side O of the packing 1 used as a buffer ring B slightly leaks on the rod packing R side by backward or forward movement of the piston 103 and rod 104. As backward or forward movement of the piston 103 and rod 104 is repeated, the operating oil leaks and accumulates, thereby filling the space S between the rod packing R and the packing 1 serving as the buffer ring B. Consequently, the pressure of the operating oil in the space S increases (i.e., the pressure accumulates).

When the oil pressure on the space S side becomes higher than the oil pressure on the oil pressure side O, the packing 1 is pressed toward the oil pressure side O, as shown in FIG. 4A. Consequently, the end face 11a of the inner circumference lip portion 11, the projecting amount of which is greater than that of the outer circumference lip portion 12, comes into contact with the side wall face 102c (on the oil pressure Side O) of the annular groove 102a. As a result of pressing the packing 1 toward the oil pressure Side O, a gap is made between the packing 1 and the side wall face on the space S side of the annular groove 102a.

Oil pressure on the space S side (opposite side to the sealed side) acts on the outer circumference side root portion of the outer circumferential lip portion 12 through the passage (i.e., pressure guide passage), shown by the arrow C, which extends through the gap made between the packing 1 and the side wall face (space S side) of the annular groove 102a and through a gap made in the contact area between the base 10 and the groove bottom face 102b by each of the slits 10b formed in the outer circumference face 10a.

When the oil pressure on the space S side further increases, the space S side oil pressure acting on the root portion elastically deforms the outer circumference lip portion 12 such that the outer circumference lip portion 12 inclines in radially inwardly direction, as shown by the arrow D. Consequently, a gap is made in the contact area between the outer circumference lip portion 12 and the bottom face 102b of the annular groove 102a. This gap and the gap made by each of the slits 10b in the outer circumference face 10a of the base enable communication between the space S side and oil pressure Side O in the contact area between the packing 1 and the groove bottom face 102b of the annular groove 102a.

In addition, since the slits 11b are formed in the end face lie of the inner circumference lip portion 11, gaps are made in the contact area between the inner circumference lip portion 11 and the side wall face 102c of the annular groove 102a.

Accordingly, the passage, as shown in the arrow E in FIG. 4B, is formed. Specifically, a passage extending across the bottom side of the annular groove 102a is formed in the packing 1. This passage enables the communication between the oil pressure Side O and the space S side of the packing 1. Thereby, high pressure on the space S leaks toward the oil pressure Side O and decreases. This makes it possible to avoid pressure accumulation in the space S.

### Excellent Features of the Embodiment

In the packing 1 according to the present embodiment, the pressure guide passage through which oil pressure on the space S side is guided to the contact area between the outer circumference lip portion 12 and the bottom face 102b of the annular groove 102a can be formed in the contact area between the base 10 and the groove bottom face 102b by the slits 10b formed in the outer circumference face 10a of the base.

This eliminates the need to deform the base 10 and enables communication between the space S side (opposite side to the sealed side) and the oil pressure Side O (sealed side) simply by deforming the outer circumference lip portion 12. That is, even when the base 10 is in close contact with the bottom face 102b of the annular groove 102a, oil pressure on the space S acts on the outer circumference lip portion 12 and deforms this lip portion 12. Accordingly, before the pressure on the space S side increases to such a high level that the base 10 is deformed, the space S side and the oil pressure Side O are enabled to communicate with each other, thereby reducing the pressure on the space S side.

In addition, the slits for the communication between the space S side and the oil pressure Side O are formed in the bottom side circumference face of the annular groove 102a, that is, in the non-slide face of the annular groove 102a. Accordingly, the adverse effects of the slits on the basic performance of the packing 1, such as, sealing function, slide characteristic, pressure resistance, and durability and the like, can be decreased. Thus, the pressure accumulation avoiding function can be stabilized.

Further, the inner circumference lip portion 11 is larger in the amount of projection than the outer circumference lip portion 12, thereby bringing the inner circumference lip portion 11 into contact with the side wall face 102c of the annular groove 102a when the packing 1 is pressed toward the oil pressure Side O. Consequently, it is suppressed that the outer circumference lip portion 12 abuts on the sidewall face 102c of the annular groove 102a and then inhibits the deformation thereof for the communication between the space S side and oil pressure Side O. This enables the outer circumference lip portion 12 to be deformed easily, and further improves the pressure accumulation avoiding function of the packing 1.

### Modified Example

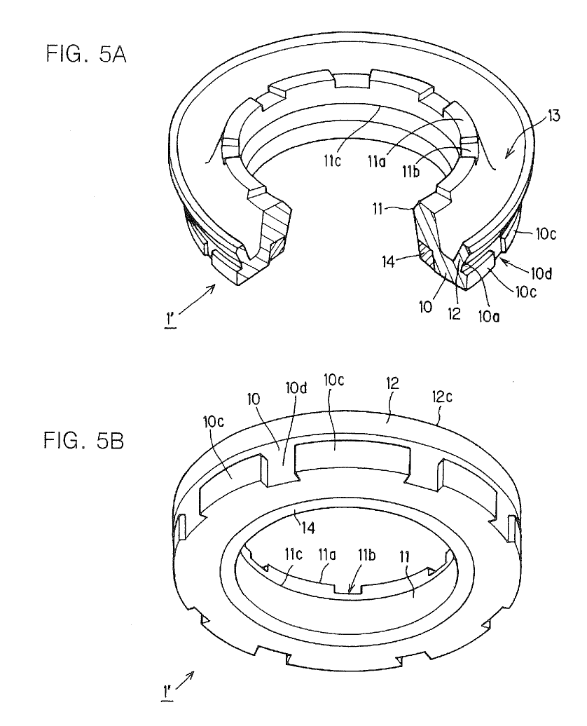

In the present embodiment, slits 10b make gaps for forming the pressure guide passage. However, the invention is not limited to this configuration so long as gaps can be made in the contact area between the base 10 and the bottom face 102b of the annular groove 102a. For example, as shown in FIG. 5, instead of forming the slits in the outer circumference face 10a of the base, a plurality of projections 10c may be formed to make gaps for defining a pressure guide passage.

Referring to FIG. 5, a packing 1′ according to a modification of the present invention will now be described. FIG. 5 is a perspective view of the configuration of the packing 1′ according to the modification. FIG. 5A is a perspective view of the packing 1′ as viewed from the sea led side, with a sectional view of the packing 1′ part of which has been removed. FIG. 5B is a perspective view of the packing 1′ as viewed from the opposite side to the sealed side. Only the features different from those of the packing in the above-described embodiment will be described below, and the common compositional members or the like are attached to the same reference numerals and the explanation thereof is not described.

In the packing 1′, a plurality of projections 10c are formed on the outer circumference face 10a of the base 10 at regular intervals in the circumferential direction, and recesses 10d are formed between the projections 10c. Accordingly, a gap is made in the contact area between the base 10 and the bottom face 102b of the annular groove 102a by the recesses 10d. Thus, a pressure guide passage capable of guiding oil pressure on the space S side into the contact area between the outer circumference lip portion 12 and the bottom face 102b of the annular groove 102a can be formed.

<Others>

In the packing 1 according the present embodiment, the axial dimension of the slits 10b in the outer circumference face 10a of the base may be shorter than the axial dimension of the outer circumference face 10a, as shown in FIGS. 1 and 2. Alternatively, as shown in FIGS. 3 and 4, the slits 10b may extend to the root portion of the outer circumference lip portion 12. To perform the pressure accumulation avoiding function more satisfactorily, the slits 10b may preferably extend to the root portion of the outer circumference lip portion 12.

In addition, it is preferable that the circumferential dimension of the slits 10b be substantially equal to the axial dimension of the base 10 from the viewpoint of the pressure resistance of the entire packing 1.

In the present embodiment, the description was given using, as an example, the rod sealing system in which the annular groove for fitting the packing therein is formed in the housing (cylinder). However, the present invention is not limited to this but can also be used in a sealing system in which the packing is fitted in an annular groove in a shaft and is slid against the inner circumference face of a housing, thereby sealing the annular gap between the shaft and housing.

The packing can be used not only in the sealing system composed of the plurality of sealing members described above but also be used as a single sealing member so long as it is to be used where pressure accumulates.

A description was given of an example where oil is sealed but the invention is not limited to this, but can be suitably used in any area where the fluid pressure of a fluid and the like can be applied.

1. A packing which is fitted in an annular groove formed in one member of a housing having a shaft hole and a shaft inserted into the shaft hole, and which seals an annular gap between these two members;
the packing having a base, and a lip portion which projects toward a sealed side from a side of the base being on the bottom side of the annular groove, and
the packing being configured such that the base and a circumferential face of the lip portion, the circumferential face being on a bottom side of the annular groove, are brought into close contact with the bottom of the annular groove, and such that when pressure on an opposite side to the sealed side becomes higher than pressure on the sealed side, the base and the lip portion are deformed to enable the sealed side and the opposite side to the sealed side to communicate in the contact areas between the base and the bottom of the annular groove and between the lip portion and the bottom of the annular groove, thereby reducing pressure on the opposite side to the sealed side, wherein:
the base has a pressure guide passage for enabling the contact area between the lip portion and the bottom of the annular groove to establish communication with the opposite side to the sealed side.

2. A packing according to claim 1, wherein, the base has a slit in a contact face between the base and the bottom of the annular groove, and the pressure guide passage is formed by a gap made in a contact area between the base and the bottom of the annular groove by the slit.

3. A packing according to claim 1, wherein, the base has a plurality of projections in a contact face between the base and the bottom of the annular groove, and a pressure guide passage is formed by gaps made between the plurality of projections.

4. A packing according to claim 1, wherein, the lip portion is a first lip portion and the packing has a second lip portion which projects toward the opposite side to the sealed side from the other member side of the base and is greater than the first lip portion in the amount of projection, and when the pressure on the opposite side to the sealed side becomes higher than the pressure on the sealed side and the packing is consequently pressed to the sealed side, the second lip portion is brought into contact with the side wall of the annular groove, the side wall being on the sealed side.

5. A packing according to claim 4, wherein the contact area between the second lip portion and the side wall of the annular groove, the side wall being on the sealed side, has a communication passage through which the bottom side of the annular groove and the opening side thereof communicate with each other.

6. A sealing system comprising:
a main seal; and
a packing according to claim 1, the packing serving as a buffer ring for the main seal.
